(19) United States
(12) Patent Application Publication
(10) Pub. No.: US 2026/0153165 A1
(43) Pub. Date: Jun. 4, 2026

(54) ACTIVATION TOOLING FOR A CONTROL COMPRISING AT LEAST ONE TOOL CONFIGURED TO COOPERATE WITH THE CONTROL AS WELL AS AT LEAST ONE DEVICE FOR HOLDING THE TOOL

(71) Applicant: Airbus Canada Limited Partnership, MIRABEL (CA)

(72) Inventors: Nicolas NUNEZ, MIRABEL (CA); Jean-Baptiste MULLER, MIRABEL (CA)

(21) Appl. No.: 19/406,394

(22) Filed: Dec. 2, 2025

(30) Foreign Application Priority Data
Dec. 3, 2024 (FR) FR2413393

(51) Int. Cl. F16K 31/46; F16K 24/04

(52) U.S. Cl. CPC F16K 31/46; F16K 24/04

(57) ABSTRACT

Activation tooling for a control integral with a support positioned in an interior zone separated from an exterior zone by a wall, the control comprising a return system tending to hold it in a deactivated state. This activation tooling includes a configured to cooperate with the control and a holding device. The holding device has a body integral with the tool and several arms connected to the body. For each arm, an abutment is connected to the arm and bears against the support or the wall. For each arm, an actuator brings the arm and the support closer together against the return system of the control.

### CROSS-REFERENCES TO RELATED APPLICATIONS

This application claims the benefit of French Patent Application Number FR2413393 filed on Dec. 3, 2024, the entire disclosure of which is incorporated herein by way of reference.

### FIELD OF THE INVENTION

The present application relates to activation tooling for a control comprising at least one tool configured to cooperate with the control as well as at least one device for holding the tool.

### BACKGROUND OF THE INVENTION

According to an embodiment from the prior art that can be seen in FIGS. 1 and 2, an aircraft comprises an outer wall 10 delimiting an interior zone ZI and an exterior zone ZE, said outer wall 10 having an opening 10.1, as well as a tank 12 arranged in the interior zone ZI, said tank 12 comprising at least one drain valve 12.1 positioned facing the opening 10.1. The outer wall 10 generally comprises a hatch (not shown) for closing the opening 10.1.

The drain valve 12.1 comprises a control 12.2 that can be moved between a first position that can be seen in FIG. 1, corresponding to a closed state of the drain valve 12.1, and a second position that can be seen in FIG. 2, offset towards the inside of the tank 12 relative to the first position and corresponding to an open state of the drain valve 12.1. Said drain valve 12.1 comprises a return system for holding the control 12.2 in the first position.

As illustrated in FIG. 2, a rod 14 is used to open the drain valve 12.1 by pushing the control 12.2 into the second position against the return system. This rod 14 extends between first and second ends 14.1, 14.2, the first end 14.1 being configured to cooperate with the control 12.2, the rod 14 being sufficiently long for an operator to hold the rod 14 from the exterior zone ZE and push the control 12.2 into the second position corresponding to the open state of the drain valve 12.1.

Depending on the quantity of fluid to be drained, the time for which the drain valve 12.1 is held in the open state may be longer or shorter.

This tool, designed to hold the drain valve 12.1 in the open state, is relatively simple. However, holding the drain valve 12.1 in the open state fully occupies an operator for the entire duration of the draining operation. Requiring the operator to keep the rod 14 depressed to hold the drain valve 12.1 open against the return system of the drain valve 12.1 is relatively tiring over an extended period.

### SUMMARY OF THE INVENTION

The present invention seeks to overcome some or all of the disadvantages of the prior art.

For this purpose, the invention relates to activation tooling for a control, configured to occupy deactivated and activated states alternately, integral with a support positioned in an interior zone separated from an exterior zone by a wall which comprises an opening providing communication between the interior and exterior zones and having a passage cross section, said control comprising a return system that tends to hold it in the deactivated state, the activation tooling comprising at least one tool configured to cooperate with the control.

According to the invention, the activation tooling comprises a holding device that includes:
a body integral with the tool,
several arms each extending between a first end connected to the body and a second end,
for each arm, at least one abutment connected to the arm, at or near the second end, and configured to bear against an element selected from the support or the wall,
for each arm, at least one actuator configured to bring the arm and the support closer to one another against the return system of the control.

This solution makes it possible to hold the control in the activated state in the absence of an operator.

According to another feature, at least one of the arms is configured to occupy a retracted state in which the holding device has a cross section smaller than the passage cross section of the opening, and a deployed state in which the holding device has a cross section greater than the passage cross section of the opening.

According to another feature, each arm comprises first and second sections as well as at least one joint connecting the first and second sections, the first section extending from the first end of the arm to the joint, the second section extending from the joint to the second end of the arm, the joint having at least one pivot axis. According to another feature, at least one of the actuators is of the passive type.

According to another feature, for at least one arm, the holding device comprises a member having at least first and second parts, the first part being connected to the arm, the second part being connected to the abutment, the actuator connecting the first and second parts.

According to another feature, the member has an adjustable length.

According to another feature, each actuator comprises at least one compression spring.

According to another feature, the holding device comprises at least one clamping system connecting the body and the tool in a releasable manner.

According to another feature, the body is tubular so as to be positioned around the tool. In addition, the clamping system comprises at least first and second jaws configured to occupy a separated state in which the tool can slide relative to the body, and a tightened state in which the body and the tool are immobile with respect to one another.

According to another feature, the holding device comprises at least one deformable spacer element positioned between the clamping system and the tool.

According to another feature, at least one of the abutments comprises a contact face, intended to be pressed against the wall or the support, which has a self-adhesive coating.

According to another feature, the holding device comprises at least one fixing system for temporarily immobilizing at least one abutment relative to the wall or the support.

### BRIEF DESCRIPTION OF THE DRAWINGS

Other features and advantages will become apparent from the description of the invention that follows, the description being given solely by way of example, with reference to the accompanying drawings in which:

FIG. 1 is a schematic representation of an aircraft tank provided with a drain valve,

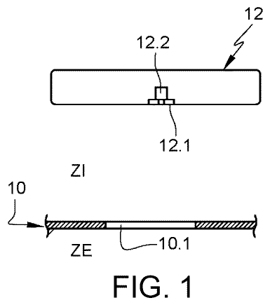

FIG. 2 is a schematic representation of a rod for controlling a drain valve, illustrating an embodiment from the prior art,

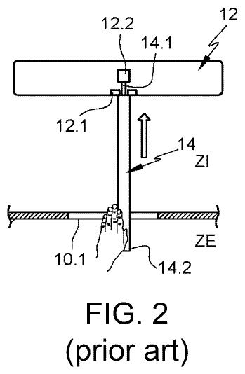

FIG. 3 is a schematic representation of activation tooling for a control, illustrating an embodiment of the invention in a disassembled state,

FIG. 4 is a schematic representation of the activation tooling for a control shown in FIG. 3 in an assembled state,

FIG. 5 is a schematic representation of a clamping system illustrating a first embodiment of the invention,

FIG. 6 is a schematic representation of a clamping system illustrating a second embodiment of the invention,

FIG. 7 is a schematic representation of the activation tooling for a control shown in FIG. 4 during a placement step,

FIG. 8 is a schematic representation of the activation tooling for a control shown in FIG. 4 during a deployment step,

FIG. 9 is a schematic representation of the activation tooling for a control shown in FIG. 4 during an actuation step,

FIG. 10 is a schematic representation of activation tooling for a control illustrating another embodiment of the invention during an activation step.

### DETAILED DESCRIPTION OF THE PREFERRED EMBODIMENTS

According to one embodiment, an aircraft comprises an outer wall 20 delimiting an interior zone ZI and an exterior zone ZE and having an opening 20.1, as well as a tank 22 arranged in the interior zone ZI, which comprises at least one drain valve 24 positioned facing the opening 20.1. The outer wall 20 generally comprises a hatch (not shown) for closing the opening 20.1. The outer wall 20 has an inner face F20 oriented towards the interior zone ZI and the tank 22. The tank 22 comprises an outer face F22 oriented towards the outer wall 20. The opening 20.1 has a given passage cross-section. In one configuration, this passage cross section is circular and has a diameter between 5 and 50 cm. The shape of the passage cross section and its diameter are given by way of example and are in no way limiting.

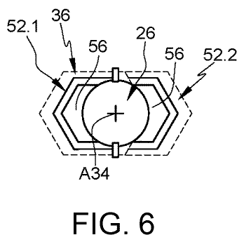

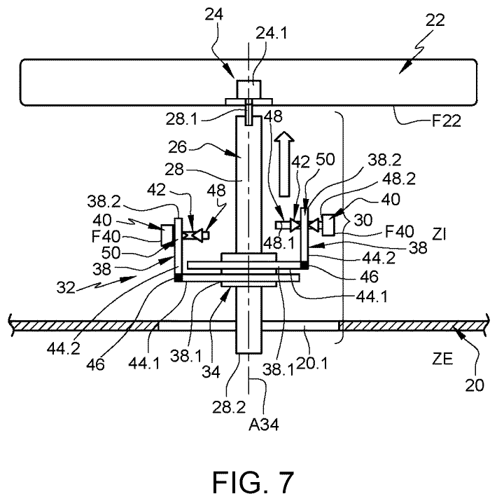

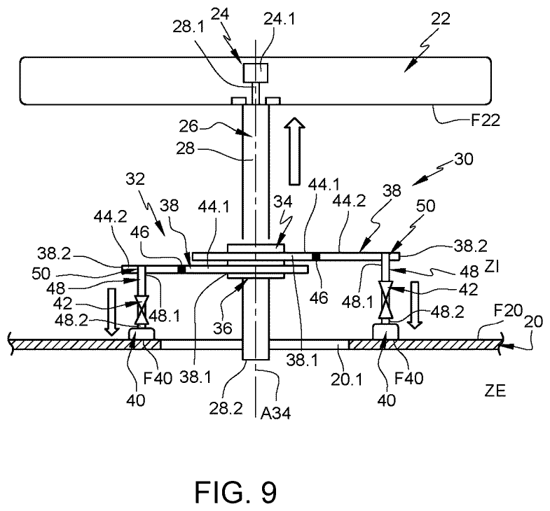

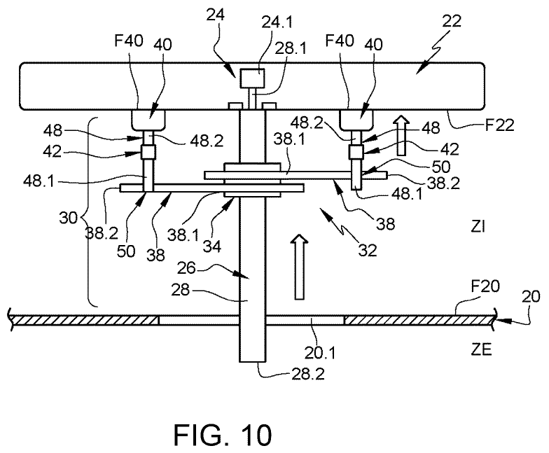

The drain valve 24 comprises a control 24.1 which is movable between a first position that can be seen in FIGS. 6 and 7, corresponding to a closed state of the drain valve 24, and a second position that can be seen in FIGS. 9 and 10, offset towards the inside of the tank 22 relative to the first position and corresponding to an open state of the drain valve 24. Said drain valve 24 comprises a return system for holding the control 24.1 in the first position. In one configuration, the control 24.1 is integrated into the drain valve 24. In another configuration, the control 24.1 is remote from the drain valve 24.

A tool 26 is configured to hold the control in the second position against the return system by passing through the outer wall 20 via the opening 20.1.

Of course, the invention is not limited to this application. Whatever the application, the tool 26 can be used to operate a control 24.1 that is movable between first and second positions corresponding to deactivated and activated states, respectively. The control 24.1 is positioned in an interior zone ZI separated from an exterior zone ZE by a wall 20 having an opening 20.1 passing therethrough and providing communication between the interior and exterior zones ZI, ZE, the control 24.1 being closer to the wall 20 in the first position than in the second position. In one embodiment, the control 24.1 comprises a return system that tends to hold it in the first position. In one arrangement, the first and second positions are oriented along an activation direction substantially (e.g., +\−10%) perpendicular to the wall 20. This activation direction is substantially centered relative to the opening 20.1.

In one configuration, the tool 26 comprises a rod 28 that extends between first and second ends 28.1, 28.2, the first end 28.1 being configured to cooperate with the control 24.1 to push it into the second position. During operation, the rod 28 is oriented parallel to the activation direction and aligned with the control 24.1. Of course, the tool 26 is not limited to a rod 28. Whatever the embodiment, the tool 26 is configured to cooperate with the control 24.1.

According to the invention, activation tooling 30 configured to hold the control 24.1 in the activated state comprises at least one tool 26 configured to cooperate with the control 24.1, as well as at least one holding device 32 configured to hold the tool 26 in a position corresponding to the activated state of the control 24.1.

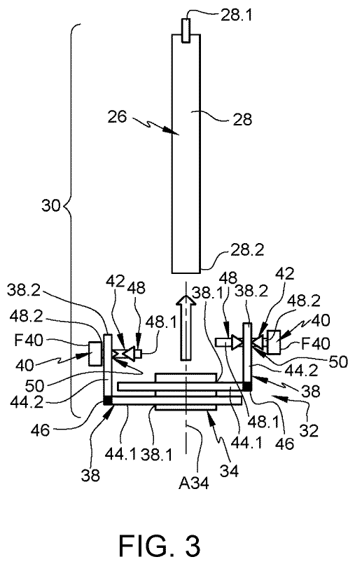

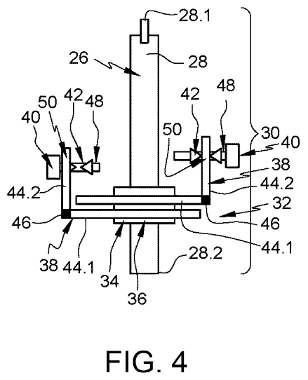

In one embodiment that can be seen in FIGS. 3, 4, and 7 to 9, the holding device 32 comprises:
at least one body 34,
at least one clamping system 36 connecting the body 34 and the tool 26 in a releasable manner,
several arms 38 each extending between a first end 38.1 connected to the body 34 and a second end 38.2, at least one of the arms being configured to occupy a retracted state in which the holding device 32 has a cross section smaller than the passage cross section of the opening 20.1 and a deployed state in which the holding device 32 has a cross section larger than the passage cross section of the opening 20.1, in such a manner that the second ends 38.2 of the arms 38 are positioned facing the wall 20 around the opening 20.1,
for each arm 38, at least one abutment 40 configured to bear against the wall 20, more particularly against its inner face F20, and connected to the arm 38, more particularly to its second end 38.2,
at least one actuator 42 for each arm 38, interposed between the arm 38 and the abutment 40 connected to the arm 38 and configured to move the arm 38 closer to the tank 22 or further away from the wall 20.

In one embodiment, all of the arms 38 are configured to occupy retracted and deployed states alternately. The holding device 32 comprises two or three arms 38 that are uniformly distributed around the body 34. The arms 38 are all of the same length.

In one configuration, each arm 38 comprises first and second sections 44.1, 44.2 as well as a joint 46 connecting the first and second sections 44.1, 44.2, the first section 44.1 extending from the first end 38.1 of the arm 38 to the joint 46, the second section 44.2 extending from the joint 46 to the second end 38.2 of the arm 38. In one embodiment, the joint 46 has at least one pivot axis to allow the second section 44.2 to occupy a first position, that can be seen in FIGS. 3, 4 and 7, in which the second section 44.2 is not aligned with the first section 44.1 and is substantially perpendicular to the first section 44.1, corresponding to the retracted state of the arm 38, and a second position, that can be seen in FIGS. 9 and 10, in which the second section 44.2 is substantially aligned with the first section 44.1, corresponding to the deployed state of the arm 38.

Each arm 38 may comprise a locking system configured to occupy a locked state in which it holds the arm 38 in the deployed state and prevents it from passing into the retracted state, as well as an unlocked state in which it allows the arm 38 to pass from the retracted state to the deployed state, and vice versa.

Of course, the invention is not limited to this configuration for allowing each arm 38 to occupy retracted and deployed states alternately. Hence, instead of being foldable, each arm 38 could be deployable or retractable.

In one embodiment, at least one of the actuators 42 is of the passive type. In this embodiment, for at least one arm 38, the holding device 32 comprises a member 48 that includes at least first and second parts 48.1, 48.2, the first part 48.1 being connected to the arm 38, the second part 48.2 being connected to the abutment 40, the actuator 42 connecting the first and second parts 48.1, 48.2. In one configuration, the first and second parts 48.1, 48.2 are segments aligned with one another. Each actuator 42 comprises at least one compression spring. In one configuration, the member 48 has an adjustable length (distance separating the arm 38 and the abutment 40). In one embodiment, the holding device 32 comprises, for at least one member 48, a sliding connection 50 that connects the member 48 and the arm 38 and allows the spacing between the arm 38 and the abutment 40 to be adjusted, as well as a locking system configured to occupy a locked state in which the member 48 is immobilized relative to the arm 38, and an unlocked state in which the member 48 can slide relative to the arm 38 so as to adjust the length of the member 48. When the arms 38 are in the deployed state, the members 48 are substantially parallel to the axis A34 of the body 34, to the activation direction or to the rod 28 of the tool 26.

In one arrangement, the holding device 32 comprises, for each arm 38, a member 48 that is adjustable in length.

Of course, the invention is not limited to this embodiment for the member 48 and the actuator 42.

In one embodiment, the body 34 may be tubular so as to be positioned around the tool 26. In this embodiment, the body 34 has an axis A34 and the arms 38 extend in a plane perpendicular to the axis A34 of the body. During operation, this axis A34 is positioned parallel to the activation direction and aligned with the control 24.1.

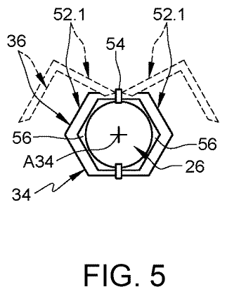

In one configuration that can be seen in FIGS. 5 and 6, the clamping system 36 comprises at least first and second jaws 52.1, 52.2 configured to occupy a separated state, corresponding to an unclamped state of the clamping system 36, in which the tool 26 can slide relative to the body 34, and a tightened state, corresponding to a clamped state of the clamping system 36, in which the first and second jaws 52.1, 52.2 are tightened around the tool 26 so that the body 34 and the tool 26 are immobile relative to one another. In a first variant that can be seen in FIG. 5, the first and second jaws 52.1, 52.2 are connected to one another by a pivot connection 54. In a second variant, that can be seen in FIG. 6, the first and second jaws 52.1, 52.2 can slide relative to one another.

In one embodiment, the holding device 32 comprises at least one deformable spacer element 56 positioned between the clamping system 36 and the tool 26. In this way, the clamping system 36 can adapt to different shapes of tools 26. By way of example, each of the first and second jaws 52.1, 52.2 comprises, on its face oriented towards the tool 26, a deformable foam coating.

Of course, the invention is not limited to these variants and embodiments for the clamping system 36.

In one embodiment, at least one abutment 40 is configured to remain immobile relative to the wall 20. In one embodiment, at least one of the abutments 40 comprises a contact face F40 intended to be pressed against the wall 20 which has a self-adhesive coating. In one configuration, the holding device 32 comprises at least one fixing system, such as a suction system that can be actuated for example, allowing at least one abutment 40 to be temporarily immobilized relative to the wall 20.

Of course, the invention is not limited to this solution for holding the abutment 40 immobile relative to the wall 20. By way of example, each abutment 40 may comprise an activatable magnetic system to keep it immobile relative to the wall 20. In this case, the wall 20 must be made of a material compatible with the magnetic system.

In one operating method, the activation method of the control 24.1 comprises a step of coupling the tool 26 and the holding device 32, as illustrated in FIGS. 3 to 6. In one operating method, with the clamping system 36 in the unclamped state, the holding device 32, more particularly the body 34 thereof, is positioned around the tool 26. When said tool 26 is correctly positioned relative to the holding device 32, the clamping system 36 is switched to the clamped state in such a manner that the tool 26 is immobilized relative to the holding device 32.

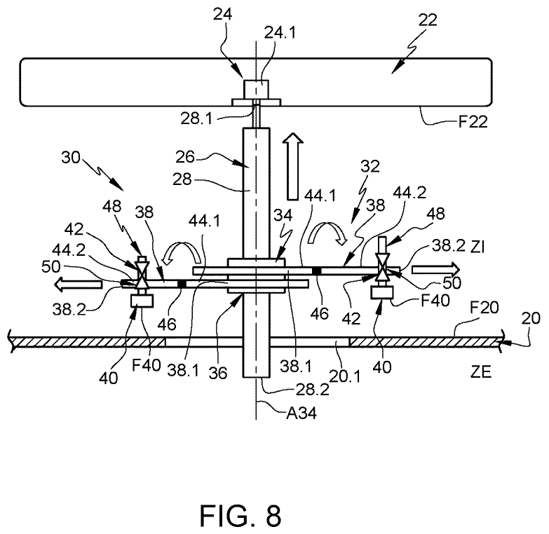

The activation method of the control 24.1 also comprises a step of placing the activation tooling 30 in the interior zone ZI, the arms 38 being in the retracted state as illustrated in FIG. 7, then a step of deploying the arms 38, as illustrated in FIG. 8, in such a manner that the abutments 40 are positioned facing the wall 20 around the opening 20.1.

Finally, the activation method of the control 24.1 comprises a step of bringing each abutment 40 into contact with the inner face F20 of the wall 20 and actuating the actuators 42 so that the tool pushes the control 24.1 into the second position corresponding to the open state of the drain valve 24.

After this last step, the activation tooling 30 makes it possible to hold the control 24.1 in the second position corresponding to the open state of the drain valve 24, without operator intervention.

Of course, the invention is not limited to this embodiment for the holding device 32. Hence, as illustrated in FIG. 10, the arms 38 and the abutment 40 could be configured in such a manner that the abutments 40 are in contact with the tank 22, more particularly with its outer face F22.

In any embodiment, a control 24.1 to be activated is movable between first and second positions corresponding to deactivated and activated states, respectively, said control 24.1 being integral with a support, such as a tank 22 for example, positioned in an interior zone ZI separated from an exterior zone ZE by a wall 20, said wall having an opening 20.1 providing communication between the interior zone ZI and the exterior zone ZE and having a passage cross section. Activation tooling 30 of the control comprises at least one tool 26 configured to activate the control 24.1 as well as at least one holding device 32 which comprises:
a body 34 integral with the tool 26,
several arms 38 each extending between a first end 38.1 connected to the body 34 and a second end 38.2,
for each arm 38, at least one abutment 40 connected to the arm 38, at or near the second end 38.2, and configured to bear against an element selected from the support (tank 22) or the wall 20,
for each arm 38, at least one actuator 42 configured to bring the arm 38 and the support (tank 22) closer together against the return system of the control 24.1.

Hence, depending on the configurations, the abutments 40 may bear against the wall 20 or the support (such as the tank 22).

This solution makes it possible to hold the control 24.1 in the activated state in the absence of an operator.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An activation tooling for a control, configured to occupy, alternatively, a deactivated state and an activated state and integral with a support positioned in an interior zone separated from an exterior zone by a wall which comprises an opening providing communication between the interior zone and the exterior zone and having a passage cross section, said control comprising a return system that tends to hold the activation tooling in the deactivated state, the activation tooling comprising:
at least one tool configured to cooperate with the control; and,
a holding device comprising:
a body integral with the at least one tool and having an axis;
a plurality of arms, each of the plurality of arms extending between a first end connected to the body and a second end, the plurality of arms extending in a plane perpendicular to the axis of the body,
for each arm of the plurality of arms, at least one abutment connected to the arm of the plurality of arms, at or near the second end, and configured to bear against either the support or the wall,
for each arm of the plurality of arms, at least one actuator configured to bring the arm of the plurality of arms and the support closer to one another against the return system of the control, wherein at least one arm of the plurality of arms is configured to occupy a retracted state in which the holding device has a cross section smaller than the passage cross section of the opening and a deployed state in which the holding device has a cross section greater than the passage cross section of the opening, and
for at least one arm of the plurality of arms, the holding device comprises a member which has a first part and a second part, the first part connected to the at least one arm of the plurality of arms, the second part connected to the at least one abutment of the at least one arm of the plurality of arms, the at least one actuator connecting the first part and the second part when the plurality of arms are in the deployed states and the members being substantially parallel to the axis of the body.

2. The activation tooling according to claim 1, wherein each arm of the plurality of arm comprises a first section, a second section, and at least one joint connecting the first section and the second section, the first section extending from the first end to the at least one joint, the second section extending from the at least one joint to the second end, the at least one joint having at least one pivot axis.

3. The activation tooling according to claim 1, wherein the member has an adjustable length.

4. The activation tooling according to claim 1, wherein the at least one actuator comprises at least one compression spring.

5. The activation tooling according to claim 1, wherein the holding device further comprises at least one clamping system connecting the body and the at least one tool in a releasable manner.

6. The activation tooling according to claim 5, wherein the body is tubular so as to be positioned around the at least one tool, and
wherein the at least one clamping system comprises a first jaw and a second jaw, the first jaw and the second jaw configured to occupy a separated state in which the at least one tool slides relative to the body and a tightened state in which the body and the at least one tool are immobile with respect to one another.

7. The activation tooling according to claim 5, wherein the holding device further comprises at least one deformable spacer element positioned between the at least one clamping system and the at least one tool.

8. The activation tooling according to claim 1, wherein the holding device further comprises at least one fixing system for temporarily immobilizing the at least one abutment relative to the wall or the support.
